(19) United States
(12) Patent Application Publication
(10) Pub. No.: US 2009/0228528 A1
(43) Pub. Date: Sep. 10, 2009

(54) SUPPORTING SUB-DOCUMENT UPDATES AND QUERIES IN AN INVERTED INDEX

(75) Inventors: Vuk Ercegovac, Campbell, CA (US); Vanja Josifovski, Los Gatos, CA (US); Ning Li, Cary, NC (US); Mauricio Mediano, Cupertino, CA (US); Eugene J. Shekita, San Jose, CA (US)

Correspondence Address: LAW OFFICE OF DONALD L. WENSKAY, P.O. Box 7206, Ranco Santa Fe, CA, 92067, US

(73) Assignee: International Business Machines Corporation, Armonk, NY (US)

(21) Appl. No.: 12/043,858

(22) Filed: Mar. 6, 2008

(51) Int. Cl. G06F 17/30

(52) U.S. Cl. 707/203; 707/E17.005

(57) ABSTRACT

A system, method, and computer program product for updating a partitioned index of a dataset. A document is indexed by separating it into indexable sections, such that different ones of the indexable sections may be contained in different partitions of the partitioned index. The partitioned index is updated using an updated version of the document by updating only those sections of the index corresponding to sections of the document that have been updated in the updated version.

### FIELD OF INVENTION

The present invention generally relates to text searching and, particularly, to systems and methods for updating and querying and inverted index used for text search.

### BACKGROUND

Inverted indexes are frequently used to support text search in a variety of enterprise applications including e-mail systems, file systems, and content management systems.

Incremental indexes are also used in enterprise applications to facilitate index updates. Incremental indexes allow the index to be updated incrementally, one document at a time. In contrast, web search engines, using inverted indexes, typically rebuild their indexes from scratch on a periodic basis to capture updates. Although incremental indexes are more update friendly, they still work at the document level, so even a single-byte update to a document requires the full document to be reindexed.

To improve the precision of text search, many applications allow search queries to include restrictions on metadata such as file type, last access time, annotations or “tags”, and so on. This metadata can be represented as special terms or XML and also searched using an inverted index. However, document metadata creates a special problem for updating indexes because metadata is often small but frequently updated.

Several inverted index designs that support incremental updates have been proposed. Much of the prior work has focused on ways to maintain clustered index structures on disk when there are updates. Some of these proposed systems use read-only partitions and merge to maintain clustering. One indexing service also provides hooks for recovery. Generally, these prior techniques also are not aggressively multi-threaded and do not allow updates, merges, and queries to all run in parallel. For example, a system known as “Lucene” is single-threaded and requires applications to build their own threading layer.

Accordingly, there is a need for a way to support updates and queries in inverted indexes. There is also a need for such techniques which can work incrementally, do not work at the document level, and which can avoid re-indexing a full document when only part of the document has been updated. There is also a need for such techniques which can allow updates, merges, and queries to run in parallel.

### SUMMARY OF THE INVENTION

To overcome the limitations in the prior art briefly described above, the present invention provides a method, a computer program product, and a system for supporting sub-document updates and queries in an inverted index.

In one embodiment of the present invention, a method of updating a partitioned index of a dataset comprises: indexing a document by separating a document into sections, wherein at least one of the sections is contained in at least one partition of the partitioned index; and updating the partitioned index using an updated version of the document by updating only those sections of the index corresponding to sections of the document that have been updated in the updated version of the document.

In another embodiment of the present invention, a method of searching a dataset having a plurality of documents comprises: indexing the dataset using a partitioned inverted index, each document having a plurality of document sections, each document section indexed by at most one partition; and searching the index by searching across the document sections.

In another embodiment of the present invention, a partitioned inverted index comprises: an ingestion thread receiving a work item and placing it in a queue; a sort-write thread for receiving the dequeuing of the work item, and sorting it to create a new index partition and writing the new index partition to disk; a merge manager thread for determining when to merge partitions; a merge thread for merging partitions in response to an instruction from the merge manager; and a state manager thread for receiving a notification from the sort-write thread of the new index partition and for updating an index state, wherein the query thread, the merge manager thread, the merge thread, and the state manager threads operate in parallel.

In a further embodiment of the present invention, a computer program product comprises a computer usable medium having a computer readable program, wherein the computer readable program when executed on a computer causes the computer to: index a document by separating a document into sections, wherein at least one of the sections is contained in at least one partition of the partitioned index; and update the partitioned index using an updated version of the document by updating only those sections of the index corresponding to sections of the document that have been updated in said updated version of said document.

Various advantages and features of novelty, which characterize the present invention, are pointed out with particularity in the claims annexed hereto and form a part hereof. However, for a better understanding of the invention and its advantages, reference should be made to the accompanying descriptive matter together with the corresponding drawings which form a further part hereof, in which there are described and illustrated specific examples in accordance with the present invention.

### BRIEF DESCRIPTION OF THE DRAWINGS

The present invention is described in conjunction with the appended drawings, where like reference numbers denote the same element throughout the set of drawings:

FIG. 1 shows a schematic diagram of a system for producing sub-document updates and queries in an inverted index in accordance with an embodiment of the invention;

FIG. 2 shows an example comparing cursor moves in local and global local zig-zag joins across index partitions used with the system shown in FIG. 1 in accordance with an embodiment of the invention;

FIG. 3 shows exemplary tree representations of local and global zig-zag query plans used with the system shown in FIG. 1 in accordance with an embodiment of the invention;

FIG. 4 shows an exemplary tree representation of the Opt query plan used with the system shown in FIG. 1 in accordance with an embodiment of the invention;

FIG. 5 shows another exemplary tree representation of the Opt query plan used with the system shown in FIG. 1 in accordance with an embodiment of the invention; and

FIG. 6 shows a high level block diagram of an information processing system useful for implementing one embodiment of the present invention.

### DETAILED DESCRIPTION OF THE INVENTION

The present invention overcomes the problems associated with the prior art by teaching a system, a computer program product, and a method for processing sub-document updates and queries in an inverted index. Embodiments of the present invention comprise an inverted index structure which may be used for enterprise applications, as well as other non-enterprise applications.

The present invention has the ability to break a document into several indexable sub-documents or sections. Each section of a document can be updated separately, but search queries can work seamlessly across all sections. This allows applications to avoid re-indexing a full document when only part of it has been updated. For example, the metadata and content of a document can be indexed as separate sections, allowing them to be updated separately, but searched together. Without sections, the only way to achieve a similar update performance would be to index the metadata and content separately at the application level, but that would require the application to join query results. The present invention solves this problem using sections in a general way, allowing queries over metadata and content to be evaluated within the same index structure, while also supporting efficient updates to the index.

Embodiments of the invention support three basic index operations: insert, delete, and query. All three operations work on either the document or section level. An update to a document (or section) is modeled as a delete followed by an insert. To support updates efficiently, an index is composed of a set of index partitions, each having a subset of the indexed documents. Index partitions are produced in two ways. A partition can be built from a main-memory staging area for new or updated documents, or by merging two or more partitions. Merging is necessary to reduce the number of partitions for query performance and also to garbage collect deleted documents.

Once an index partition is built, it is never changed, that is, partitions become read-only after being created. This enables the invention to use highly compressed indexes, and also ensures that queries can be executed against a stable set of read-only partitions. Index partitions are continuously built and merged in the background using efficient sequential I/O. Managing this process in parallel without interrupting queries is an important part of this process.

The invention may also provide hooks for applications that need a recoverable inverted index. A sequence number is returned to the application for every insert and delete operation it executes. After a system crash, the application can ask what operation has been stably written to disk and take appropriate action. Delete operations are recorded in the index itself, making it easy to perform index recovery in a way that preserves the order of insert and delete operations.

The following disclosure described additional details of exemplary embodiments of the invention and how it supports sub-document updates and queries using the notion of sections. The invention includes the overall design of the inverted index structure and a query execution process.

Although sections used by the invention help improve update performance, query performance can suffer because each section of a document may appear in a different index partition, requiring a query to be evaluated across partitions rather than on one partition at a time. To deal with this issue, a query execution process is disclosed to exploit knowledge about sections and index partitions to minimize the number of index cursor moves needed to evaluate a query. Experimental results on patent data show that, with the optimized process, sections can dramatically improve update performance without noticeably degrading query performance.

The present invention supports updateable sections. In contrast, prior system for updating inverted indexes could not support updateable sections. Also, as compared to prior systems, the present invention is more aggressively multi-threaded, allowing updates, merges, and queries to all run in parallel. Lucene, for example, is single-threaded and requires applications to build their own threading layer.

The present invention uses the document at a time (DAAT) query execution model, known to those skilled in the art. The query execution process used with the present invention builds on previous work on zig-zag joins and the WAND operator in that it intelligently moves index cursors to intersect posting lists. However, previous index designs did not deal with a partitioned index design where each section of a document may appear in a different partition.

### Inverted Index Structure

Embodiments of the invention use a traditional inverted index structure for each index partition. A posting list is maintained for every distinct term t in the dataset, where a term can be a text or metadata value. The posting list for t contains one posting for each occurrence of t and has the form<docid, sectid, payload>, where docid corresponds to document ID, and sectid to section ID. The payload is used to store arbitrary information about each occurrence of t, like its offset within the document. Those skilled in the art will understand the details of what is stored in the payload and how posting lists are compressed and, thus, need not be explained herein.

For a term t, in embodiments of the invention, all instances of t across all sections may be kept in one posting list. An alternative design would be to separate the posting lists by sectid. Either alternative would be straightforward to implement in the present invention. In embodiments discussed herein, the former design will be assumed because it provides better compression and is better for queries across sections, that is, “sect*” queries. The query execution processes described below are orthogonal to this design choice.

A B-tree like structure is used to index posting lists. Each posting list is sorted in increasing order on docid and sectid, enabling query execution to quickly intersect posting lists. A posting list on a token t is accessed via an index cursor on t. Using the B-tree, a cursor can skip over postings that do not match. The two most basic methods on a cursor c are c.posting( ) to read the current posting and c.next(d) to move the cursor to the next posting whose docid is≧d. If d is omitted, the cursor just moves to the next posting.

To support section-level updates in the present invention, each section of a document can appear in a different index partition. This is in contrast to other partitioned index designs where a full document can appear in only one partition. It is noted that, although the sections of a document can be spread across index partitions, an individual section must be fully contained within one partition.

A unique, permanent docid is assigned to every document and used to globally intersect posting lists across partitions. The sectid of a posting can be thought of as a small number of bits in addition to its docid.

### Architecture and Basic Operation

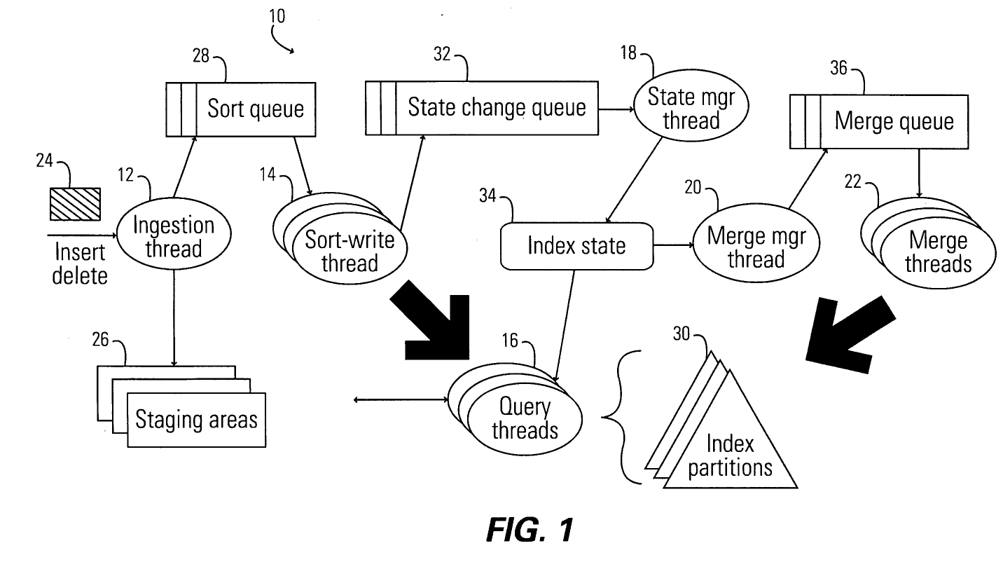

FIG. 1 shows a schematic diagram of a system 10 for producing subdocument updates and queries in an inverted index in accordance with an embodiment of the invention. The system 10 has been designed to take advantage of modern multi-core processors, with multiple threads for building and merging index partitions in parallel. Those skilled in the art will appreciate that the term “thread” in this context means a thread of execution, which is an independent stream of instructions that can be scheduled to run as such by the operation system.

FIG. 1 shows a series of threads, which include an ingestion thread 12, sort-write threads 14, query threads 16, a state manager thread 18, a merge manager thread 20, and merge threads 22. Query threads 16 are threads that evaluate a single query. All these threads communicate and synchronize their activity using producer-consumer queues, which include sort queues 28, state change queues 32, and a merge queue 36. As used herein, a queue is a data structure that contains a list of items. The oldest item is said to be at the front of the queue and the newest item is said to be at the back of the queue. The queues are typically manipulated using an enqueues (insert an item at the back of the queue) and a dequeue (remove an item from the front of the queue). The queue data structure is used to implement a first-in-first-out servicing policy (FIFO). Sections are handled much like full documents in insert and delete operations, so we will not distinguish between sections and documents in the discussion of those operations except when necessary.

As shown in FIG. 1, an application (not shown) passes a new document (or section) 24 to be inserted to ingestion thread 12, which prepares the document for insertion by appending it to one of the main-memory staging areas 26. Multiple staging areas allow an index partition to be built from one staging area as another is being filled. A staging area holds only tokenized documents. Those skilled in the art will understand the details of how documents are parsed and tokenized, so they need not be discussed herein.

When a staging area 26 “S”fills up, the ingestion thread 12 enqueues a work item for it on a sort queue 28. A free sort-write thread 14 dequeues the work item, sorts S to create a new index partition 30 “P”, and then writes P to disk (not shown), after which S is available to be filled again.

After an index partition 30 (P) has been written to disk, the sort-write thread 14 notifies the state manager thread 18 about P. A set of partitions 30 that represent a consistent index state (shown in FIG. 1 as index state 34) for queries is called an epoch. The state manager thread 18 keeps track of the current epoch for incoming queries, as well as older epochs still in use by queries. The index state 34 is also read by the merge manager thread 20 to determine when to merge partitions, as described in more detail below. The state change queue 32 is a queue of the state change work items. Sort-write threads 14 enqueue state change work items and the state manager thread 18 dequeues to advance the index. The merge queue 36 is a queue of merge work items. The merge manager thread 20 enqueues merge work items and the merge threads 22 dequeue merge work items to merge index partitions 30.

Note that there is a latency between the time a document is inserted into the staging area 26 by an application and the time when it actually appears in the index for search queries. Bigger staging areas 26 make the index build process more efficient but increase this latency. Indexing latency does not present a problem in most search applications since their queries are inherently imprecise. However, to exert more control over the system 10, applications can specify a latency threshold t, forcing a partition to be built from a partially filled staging area if it contains documents older than t seconds.

Applications delete a document (or section) by passing a “tombstone” token for the document to the ingestion thread 12, which appends the tombstone to the current staging area. If the deleted document appears in the staging area 26 before the tombstone token for it is appended, then the document will be removed from the staging area. Otherwise, the deleted document is recorded in a special tombstone posting list when the index partition for the staging area 26 is built. Let P₁, P₂, . . . , Pₙ be the order in which index partitions 30 are built. The tombstone posting list for Pᵢ records all the documents that have been deleted in partitions that are older than Pᵢ, that is Pₖ: k<i. It is used in query execution to filter out deleted documents (or sections) in older partitions on disk that have yet to be garbage collected during the merge process. Note that the tombstone posting list for Pᵢ does not filter out documents in Pᵢ itself.

How tombstone posting lists work at the section level is shown as follows:

$$\begin{matrix}{P}_{1} \\ older\end{matrix} \{ \begin{matrix}A \text{:} < {D}_{1} , {S}_{2} > \\ B \text{:} < D , {S}_{2} >\end{matrix} \begin{matrix}{P}_{2} \\ newer\end{matrix} \{ \begin{matrix}tombstone \\ A \text{:} < {D}_{1} , {S}_{2} > \\ C \text{:} < {D}_{1} , {S}_{2} >\end{matrix}$$

The older partition P₁ contains postings for tokens A and B in section S₂ of document D₁. That section has been deleted then reinserted in P₂. The tombstone posting list in P₂ will cause the postings for A and B in P₁ to be filtered out during query execution. However, the tombstone posting list in P₂ will not affect the postings for A and C in P₂, since those were inserted after the deletion. Using tombstone posting lists to record delete operations greatly simplifies recovery. This is because both insert and delete operations are effectively committed together when an index partition is written to disk, enabling the disk-write of a partition to serve as the unit of recovery. In contrast, if a separate data structure was used to record delete operations, as in Lucene, it would have to be locked and carefully forced to disk at the appropriate time to ensure that the order of inserts and deletes could be preserved during recovery.

Incoming queries are always directed to the current epoch. An index partition that does not belong to the current epoch and is no longer being used by any queries can be deleted. Epoch Eᵢ₊₁ will share the same partitions as the previous epoch Eᵢ except for partitions that have been added or merged. Any time a new partition is produced by a sort-write thread 14 or a merge thread 22, the state manager thread 18 is notified so it can update the index state 34, as illustrated in FIG. 1. The state manager thread 18 is also responsible for writing the index state 34 to disk for recovery. The system 10 takes measures to ensure that partitions and its index state 34 are kept consistent on disk, cleaning up any inconsistent data structures when it is restarted.

The system 10 does not maintain its own log for recovery, nor does it handle undo or redo. However, it does provide hooks for applications to orchestrate recovery. An operation sequence number (OSN) is returned to the application for every insert and delete operation. At any time, the application can ask the system 10 for the sequence number of the last operation that has been committed to disk (LCSN). Then, after a crash, the application can use this to redo any operations that have been lost since it last took a checkpoint, i.e., those with an OSN>LCSN. Since insert and delete operations are recorded in posting lists, the LCSN is equal to the largest OSN recorded in newest partition that was stably written to disk.

Some applications require an insert or delete operation to return only after it has been stably written to disk and/or reflected in the index for queries. Both of these requirements can be implemented by simply polling the LCSN and delaying the operation's return until its OSN≧LCSN.

Query performance degrades with the number of index partitions 30 because of processing overhead associated with each partition and because the postings of deleted documents accumulate in old partitions, causing the index to be bigger than it needs to be. To keep the number of partitions 30 in check and to garbage collect the postings of deleted documents, partitions are continuously merged into larger partitions. The merge manager thread 20 shown in FIG. 1 initiates a merge, which is carried out by a merge thread 22. To deal with heavy insert workloads, multiple merge threads 22 can be active at the same time, each merging a disjoint set of partitions 30.

The process used to merge ordinary posting lists in partitions Pₓ, . . . , P_{y} of the index is shown as follows:

```
Index: :merge(Px, ..., Py, THASH)  1. open a ‘*’ cursor on each
            index partition to be merged;
    2.  initialize a min heap over the cursors;
    3.  while (the heap is not empty) {
    4.  min = heap.deleteMin( );
    5.  p = min.posting( );
    6.  min.next( );
    7.  heap.insert(min);
    8.  check THASH for a entry matching p
          from a newer partition than p;
    9.  if (there is no match for p in THASH) {
    10.  add p to the merged result;
    11.  }
    12. }
```

For each partition Pᵢ to be merged, the process opens a special “*” cursor (line 1), which is used to iterate all the postings of Pᵢ in (token, docid, sectid) order. A min heap on the cursors is initialized (line 2) and used to enumerate postings in the above order (line 4). Each posting is checked for a “match” against a tombstone hash (THASH), which is derived from the current epoch. Additional details about this will be discussed below. Postings that survive this check are added to the merged result (line 10). After the merge completes, the resulting partition is assigned the same timestamp as P_{y}, i.e., the merged partition replaces P_{y}.

The tombstone hash (THASH) is a main-memory hash table that is built from the tombstone posting lists. Recall that the tombstone posting list for Pᵢ records the documents (or sections) that have been deleted in partitions that are older than Pᵢ, that is Pₖ: k<i. Therefore, to determine whether a posting p should appear in the merged result, we simply check if there is an entry in the THASH from a newer partition that matches p on docid and sectid. If no match is found, then p can be added to the merged result. In case the whole document has been deleted, only the docid is checked for a match, that is, the sectid is masked out.

Note that the THASH does not need to be precise. For example, suppose there are three consecutive index partitions Pᵢ, Pⱼ, and Pₖ, l<j<k, and the merge policy has chosen to merge Pᵢ, and Pⱼ, the THASH could include the tombstone posting list from Pₖ, but it does not have to, since the query runtime will still use Pₖ's tombstone posting list to filter out deleted postings from the merged result during query execution. The upside of including Pₖ's tombstone posting list in the THASH is that the merge process can do a better job of garbage collection. The downside is the cost of reading Pₖ's tombstone posting list from disk and adding it to THASH. This suggests two strategies for building the THASH:

Lazy. Only the tombstone posting lists of the partitions to be merged are used to build the THASH.

Aggressive. The tombstone posting lists of the partitions to be merged and those of newer partitions are used to build the THASH.

A hybrid strategy somewhere in between these two is also possible. In practice, we have found that the aggressive strategy leads to smaller indexes and better query performance, so that is the default strategy used in this embodiment of the system 10.

In addition to ordinary posting lists, tombstone posting lists also have to be merged and garbage collected. We omit the process for this since it is straightforward. The key observation to note is that a tombstone posting for document D in partition Pᵢ can be garbage collected if Pᵢ is the oldest partition or if a tombstone posting for D appears in a newer partition than Pᵢ. A lazy or aggressive strategy can also be used to garbage collect tombstone posting lists. The merge manager thread 20 runs the merge policy to determine which index partitions to merge. The system 10 supports a flexible merge policy that can be tuned for the system resources available and the application workload. The merge policy basically determines when to trigger a merge, and which partitions 30 to merge. To ensure that the order of insert and delete operations are maintained, only consecutive partitions 30 can be merged.

The default merge policy used in this embodiment is an adaptation of the one used in Lucene. The basic idea is to merge k consecutive index partitions with roughly the same size, where the merge degree k is a configuration parameter. Once a merge finishes, it can trigger further merges in a cascading manner. When a partition Pᵢ is merged, it will be merged into a new partition that is roughly k times bigger than Pᵢ. The end result is a set of partitions that increase geometrically in size, with newer unmerged partitions being the smallest.

### Query Execution

Without sections, a query can be evaluated locally on one partition at a time, and then the results from each partition can be unioned. This is the execution strategy used in other partitioned index designs. In contrast, with sections, a query has to be evaluated globally across index partitions, since each section of a document may appear in a different partition. Unfortunately, as our experimental results will show, this can cause query performance to suffer.

In this section, we describe a naive query execution process that is simple to understand and implement but may perform unsatisfactorily on certain workloads. We then describe a more complicated process that exploits knowledge about sections and index partitions to achieve better query performance. We will ignore ranking and only focus on how the list of candidate docids matching a query is found using the inverted index.

The details of the syntax for queries will be understood by those skilled in the art.
In general, queries will be in the form:
(sect1: A and B) and (sect2: C and D)

This query matches documents with terms A and B in section 1, and C and D in section 2. The wildcard section “sect*” is also available for matching any section. We do not expect a user to type in these kind of queries directly. The assumption is that they are generated by the application as a result of the user's input. The execution methods described below can support arbitrary Boolean queries. However, the focus here will be on evaluating AND queries, since query performance hinges on evaluating AND predicates efficiently.

A query plan for an inverted index can be constructed from base cursors and higher-level Boolean operators that share a common interface. For an AND query with k terms, the query plan becomes a simple two-level tree, with an AND operator at the root level and its input base cursors at the leaf level. The AND operator intersects the posting lists of its inputs to produce an ordered stream of docids for documents that contain all k terms. Because the posting lists are in docid order, this intersection can be done efficiently using a k-way zig-zag join on docid. Those skilled in the art will appreciate that a zig-zag join is a specific implementation of a join between two relations R and S. A join is defined as their cross-product that is pruned by a selection.

The easiest way to handle both sections and index partitions during query execution is to define a virtual cursor class that implements the base cursor interface. These virtual cursors hide the details of sections and index partitions, allowing them to be plugged into higher-level operators as though they were base cursors. This is what the Naive method does. We call these virtual cursors “global” cursors because they work globally across index partitions. The open( ) and next( ) methods for global cursors are described below.

The global cursor open( ) method is shown below.

GlobalCursor: :open(t, s)

1. open a filtered base cursor for (t, s)
on each index partition;
2. initialize a min heap over the cursors;
3. min = heap.deleteMin( );
4. p = min.posting( );

Let t be a query term and s its section restriction. The open( ) method begins by opening a “filtered” base cursor for (t, s) on each index partition. A filtered cursor on (t, s) will only enumerate valid postings for t from section s. Postings from other sections and deleted postings will be filtered out. A main-memory hash table similar to the tombstone hash described earlier is maintained for each index partition to filter out deleted postings.

After opening the filtered base cursors, a min heap on the cursors is initialized (line 2) and used to find the “min cursor” (line 3), that is, the cursor whose posting has the smallest docid. The global cursor's current posting, which is derived from the min cursor, is kept in the object variable p (line 4). The global cursor next( ) method is shown below.

GlobalCursor::next(d)

1. while (p.docid < d) {
2. min.next(d);
3. heap.insert(min);
4. if (the heap is empty) {
5. return eof;
6. }
7. min = heap.deleteMin( );
8. p = min.posting( );
9. }

This process keeps looping until the heap becomes empty and “eof” is returned (line 5), or until the min cursor is on a posting whose docid≧d. Those skilled in the art will appreciate that “heap” is a specialized tree-based data structure that satisfies certain properties. The min cursor is moved forward using its base next( ) method (line 2). The heap is used to find the next min cursor (line 7), after which p is reset (line 8).

By using global cursors, the naive process effectively causes an AND query to be evaluated with a global zig-zag join across index partitions. This is in contrast to other partitioned index designs where a full document can appear in only one partition, allowing a local zig-zag join to be used on each partition. However, a global zig-zag can require more cursor moves than a local zig-zag, which is undesirable since each cursor move can trigger an I/O and degrade query performance. The data and instruction cache locality of a global zig-zag is also worse, which only adds to the problem.

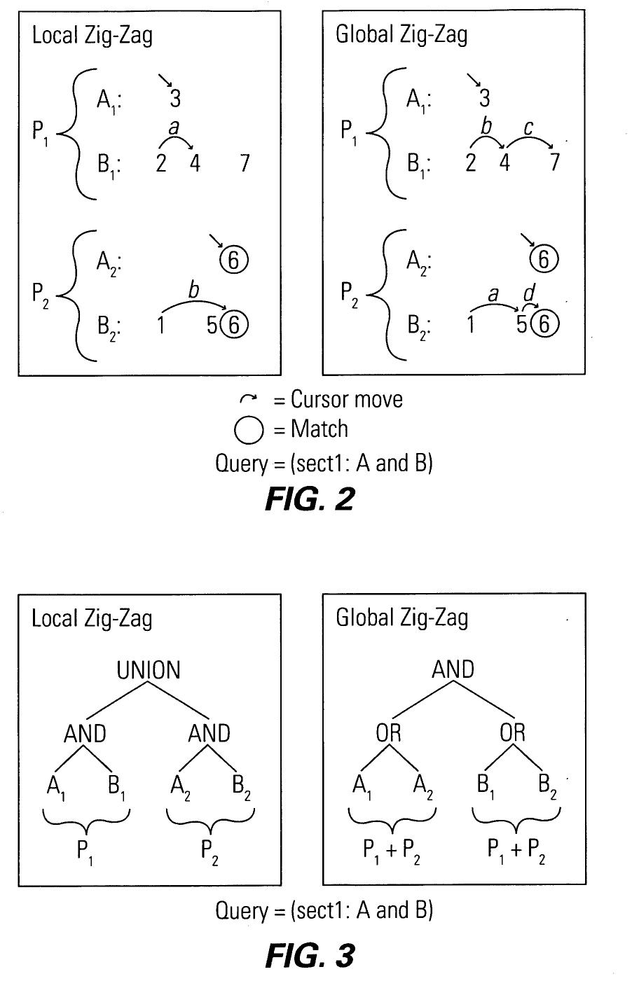

The reason a global zig-zag can require more cursor moves is because of the way the global next(d) method works. In particular, all the underlying base cursors, one for each index partition, must be moved to a position≧d. In comparison, with a local zig-zag, next(d) will only move one base cursor. FIG. 2 shows an example to illustrate the difference between a local and global zig-zag. There are two terms in the query, A and B, both for the same section, and two index partitions P₁ and P₂. Subscriptᵢ is used to denote partition Pᵢ, so Aᵢ denotes the A base cursor on partition Pᵢ and similarly for the B cursors. Posting lists are to the right of the cursors. Docids are shown as simple integers, and lowercase letters are used to label cursor moves. Subsequent examples will use this same notation.

As shown in FIG. 2, the B cursor has to be moved twice as many times in the global zig-zag. In the local case, the join is performed separately on P₁ and then P₂. Consequently, A₁ on 3 causes move a on B₁, and A₂ on 6 causes move b on B₂. In contrast, because of the way the global next( ) works across partitions, each A posting causes B to be moved in both P₁ and P₂. As shown, A₁ on 3 causes move a on B₂ and b on B₁, and then A₂ on 6 causes move con B₁ and don B₂. Of course, this is an extreme example, but our experimental results will show that global zig-zags do perform more cursor moves on average.

Closer inspection of the global next( ) method reveals that it effectively implements an OR operator, where OR is defined as the current min docid of its inputs. A global zig-zag plan can therefore be represented as a tree of AND and OR nodes. To represent the local zig-zag plan as a tree, we need to introduce a UNION operator, which concatenates its inputs from left to right. Using these operators, the local and global plans for a simple query are shown in FIG. 3. In FIG. 3, we have assumed two index partitions P₁ and P₂. Leaf nodes correspond to filtered base cursors in the global plan. Aᵢ denotes the A base cursor on partition Pᵢ and similarly for the B cursors. Looking at the two plans, it should be clear why the local plan performs better. This is because the more restrictive AND operator is pushed further down the tree.

The local zig-zag plan uses the knowledge that a document cannot appear in more than one index partition to push AND operators down. With sections, this is not possible, since the sections of a document can appear in different partitions. However, we can use the knowledge that a section of a document cannot appear in more than one partition to push down AND operators. This is achieved using a process we call the “Opt” method.

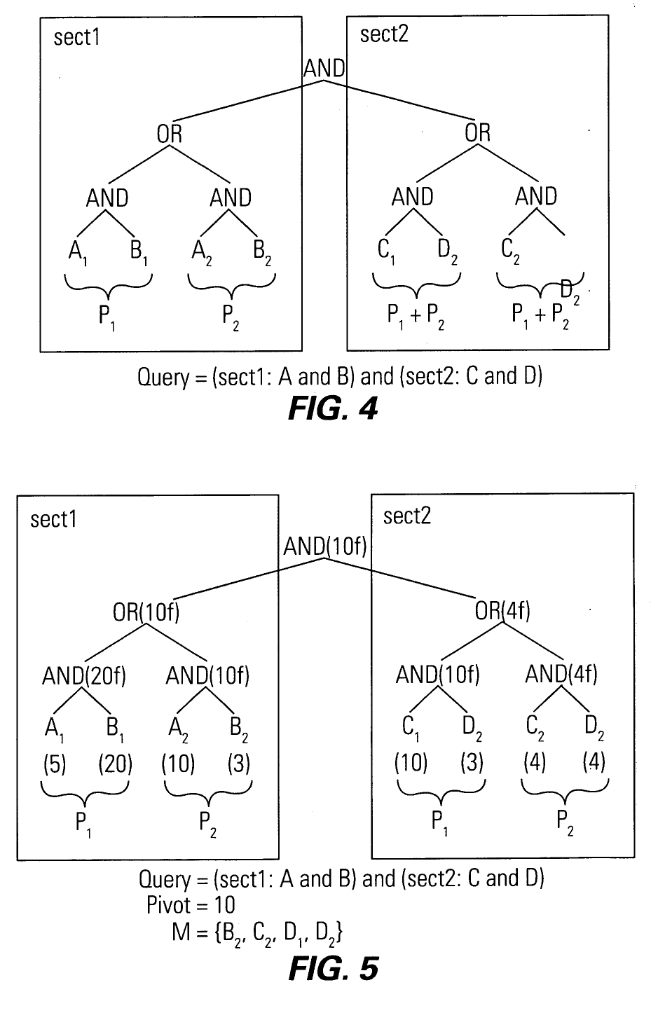

Consider the example query used earlier:
(sect1: A and B) and (sect2: C and D)
The Opt method recognizes that, because they are both from sect1, a match for A and B must be found in the same partition. Consequently, a per-partition AND can be done for them like in a local zig-zag, and similarly for C and D. The resulting Opt plan for this query is shown in FIG. 4.

A query plan like the one shown in FIG. 4 could be directly executed, letting each AND operator make its own local decisions about which cursor to move next in the search for a match. But it is possible to do better. Using an understanding of holistic twig joins, we have designed the Opt method to look holistically at the state of all cursors in the plan when it decides which cursor to move next. This enables it to push knowledge about sections and partitions down one step further to minimize the number of cursor moves.

The input to the Opt method is a query plan Q. Each interior node in Q includes a docid to record the position of the node and a Boolean match flag to record information about whether a match has been found. Leaf nodes correspond to filtered base cursors. In addition to its docid and sectid, each cursor also includes a partition identifier partid and a match flag. Finally a global pivot variable is kept. The notion of a pivot is known in the art. At any time, the pivot represents the minimum docid where the next match could occur. It may be noted that in some previous work on the pivot a per-operator pivot was computed, whereas here the pivot is computed holistically over all of Q.

The top level of the Opt method is shown below.

ExecuteQuery( )

1. open the filtered base cursors for Q;
2. pivot = −1;
3. r = Q.root;
4. while (not done) {
5. FindPivot(r);
6. M = empty set;
7. CheckMatch(r, M);
8. if (r.match == true) {
9. output pivot;
10. }
11. else {
12. ComputeMoveSet(r, M);
13. }
14. if (M is empty) {
15. pivot++;
16. }
17. else {
18. b = best cursor in M to move;
19. b.next(pivot);
20. }
21. }

Query execution begins by opening the filtered base cursors for Q, initializing the pivot, and remembering Q's root in r (lines 1-3). The method keeps looping until the cursor positions indicate that no more matches are possible (line 4). On each loop, a new pivot is found in FindPivot( ), and then CheckMatch( ) is called to check for a match on the pivot (lines 5-7). If a match is found, r.match will be set to True, causing the pivot to be output (lines 8-10). Otherwise, the “move set” M is computed (lines 11-13), which corresponds to the set of cursors that need to be moved to find a match on the pivot. If M is empty, there is already a match on the pivot or a match on the pivot is impossible. In either case, the pivot can be incremented (lines 14-16). If M is not empty, then some cursor needs to be moved to find a match on the pivot. The “best” cursor in M is picked and moved≧pivot (lines 17-20). Those skilled in the art will understand that there are various ways to pick the best cursor to move; nominally the one with the largest inverse document frequency (IDF) can be used.

The function to find a new pivot is shown below.

FindPivot(q)

1. for (each child c of q) {
2. FindPivot(c);
3. }
4. if (q is OR node) {
5. m = the child of q with min docid;
6. }
7. else if (q is AND node) {
8. m = the child of q with max docid;
9. }
10. q = m.docid;
11. if (q == Q.root) {
12. pivot = max(pivot, q.docid);
13. }

This function makes a post-order traversal of Q. On each OR node, the min docid of its inputs is copied, while the max docid is used for each AND node (lines 4-9). When Q's root has been reached, the new pivot is set (lines 11-13). The root's docid may still be equal to the previous pivot at this point, so the max( ) is taken to insure that the pivot does not go backwards.

The function to check for a match on the pivot is shown below.

CheckMatch(q, M)

1. for (each child c of q) {
2. CheckMatch(c, M);
3. }
4. q.match = false; // assume false
5. if (q isOR node) {
6. if (any input of q is true) {
7. q.match = true;
8. }
9. }
10. else if (q is AND node) {
11. if (all inputs of q are true) {
12. q.match = true;
13. }
14. }
15. else { // base cursor
16. if (q.docid == pivot or q is in M) {
17. q.match = true;
18. }
19. }

For now, the move set M can be assumed to be empty. This assumption will be dropped later when we extend the basic Opt method. The check for a match is made with a post-order traversal of Q. When CheckMatch( ) exits, the match flag of Q's root will be set to True if there is a match on the pivot, and False otherwise. The function to compute the move set M is shown below.

ComputeMoveSet(q, M)

1. for (each child c of q) {
2. if (c is OR or AND node and
c.docid <= pivot) {
3. ComputeMoveSet(c, M);
4. }
5. else if (c.docid < pivot) {
6. add c's cursor to M;
7. }
8. }

This function makes yet another post-order traversal of Q. Interior nodes only need to be traversed if their docid is≦the pivot (lines 2-4). When a base cursor is reached (lines 5-7), the cursor is added to M if its docid is<the pivot.

An example of how the Opt method works on the query plan presented earlier is shown in FIG. 5. The docid and match flag of each node, which are set in FindPivot( ) and CheckMatch( ), respectively, are shown in parenthesis. The root AND node indicates that the pivot is 10, but there is currently not a match on the pivot. The move set M includes all the cursors<10 except for A₁. That cursor is excluded from M because the B₁ cursor did not include 10 and has already moved beyond it. This in turn means that there is no way for the left-most lower AND node to match on 10.

It is worth observing that, except at the base cursor level, the basic Opt method described up to this point has no awareness of sections. As a result, it is a general method that can also be applied to traditional inverted indexes without support for sections. Moreover, the same method will work on arbitrary AND-OR Boolean queries. However, the pruning of the move set, which is described next, only applies to a partitioned index with support for sections. The basic Opt method improves on prior work by holistically finding the pivot and computing the move set over all of Q rather than on a per-operator basis.

The move set found in the basic Opt method is not optimal. This can be seen by turning to FIG. 5 again. The fact that C₁ is on the pivot (10) means that C₂ and D₂ can never match on 10. This is because a section of a document can never appear in more than one index partition. In this case, C₁ tells us that sect2 of document 10 is in P₁, which means it cannot appear in P₂. To further improve the Opt method's performance, the move set M can be pruned using this knowledge. The pruning rule is as follows: let each base cursor state be represented as a triple (docid, sectid, partid). If the state of some base cursor is (pivot, s, p), that is, the cursor is on the pivot, then remove cursors from M with state (-, s, p̅), where ‘-’ matches any docid and p̅ means any partition other than p. Sect* cursors can be used to prune cursors in M, but sect* cursors cannot be pruned from M using this rule, since their section can change from posting to posting. After this rule is applied to FIG. 13, the move set will be reduced to M={B₂, D₁}.

Note that in some cases M can become empty after pruning. For example, if B₂ was on 10 and D₁ was on 13 in FIG. 5, then M would become empty after pruning. In this case, a match on the pivot is impossible because no cursors can be moved to find a match. However, even if M is not empty, a match on the pivot may still be impossible. For example, if B₂ remained on 3 and D₁ was on 13 in FIG. 13, then M={B₂} after pruning. In this case, M is not empty, but a match on the pivot is still impossible because of D₁. Both of these cases are handled by checking for a potential match on the pivot by calling CheckMatch( ) with the pruned M.

To add pruning for M to the Opt method, only a few lines need to be added to ExecuteQuery( ), as shown below.

ExecuteQuery( )

...
12. ComputeMoveSet(r, M); // same as before
12.1 prune M using the pruning rule;
12.2 if (M is not empty) {
12.3 CheckMatch(r, M);
12.4 if (r.match == false) {
12.5 M = empty set;
12.6 }
12.7 r.match = false;
12.8 }
...

M is pruned using the pruning rule described above (line 12.1). If M is empty after pruning, a match on the pivot is impossible. Otherwise, a check for a potential match on the pivot is made using the pruned M (line 12.3). In contrast to the first call to CheckMatch( ), M will not be empty this time, causing CheckMatch( ) to assume that any cursor in M could be moved to match the pivot. If this second check fails, a match on the pivot is impossible; this is indicated by setting M to empty (lines 12.4-12.5). Finally, the root's match flag needs to be reset, since a potential match is not a real match (line 12.7).

In a practical embodiments of the Opt method, care should be taken to minimize the number of passes that are made over Q for every cursor move. Otherwise, the CPU cost of the Opt method can become high. To make the method easier to understand, we have not worried about this in the present discussion. However, the basic idea is to add information to each node of Q and combine parts of FindPivot( ) and CheckMatch( ) so the pivot can be computed and checked for a match in just one pass of Q. Also, note that lines 12.2-12.8 in the above pruning method are needed to claim optimality but not for correctness. Removing those lines can eliminate another pass over Q. The experimental results presented and discussed below were based on an implementation with these changes.

The following observation may be made about the Opt method's optimality.

Theorem: Given a query plan Q and cursor state C, whenever a cursor is moved:
It is necessary to move one of the cursors in the pruned move set M to find a match.
The cursor that is moved is moved as far forward as possible without missing a match.
   Proof Sketch The first part of the theorem follows from the way the pivot and M are computed. It should be clear that when Find-Pivot( ) exits, the pivot has been set to the minimum docid where the next match could occur. Moreover, ComputeMoveSet( ) only adds cursors to M that are less than the pivot. Finally, cursors that cannot match the pivot are pruned from M. The second part of the theorem follows directly from the definition of the pivot.
   Note that if |M|>1, the method chooses the “best” cursor to move using heuristics based on available statistics. This means that the method is not instance optimal, since instance optimality can only be achieved if there was a way to always choose the best cursor to move. However, this theorem does guarantee that when a cursor is moved, it is moved as far forward as possible without missing a match.

### CONCLUSION

The present invention includes embodiments of an inverted index for enterprise or other applications that supports sub-document updates and queries using “sections”. Each section of a document can be updated separately, but search queries can work seamlessly across all sections. This allows applications to avoid re-indexing a full document when only part of it has been updated.

Experiments have been conducted that compare an optimized execution method (Opt) to a naive one (Naive). The results showed that, with the Opt method, sections can dramatically improve update performance without noticeably degrading query performance. The Opt method achieves its performance by exploiting information about sections and index partitions to minimize the number of index cursor moves needed to evaluate a query. Given a query plan, the Opt method holistically determines which is the best cursor to move next and how far to move it. The same basic method can also be used with traditional inverted indexes without support for sections to optimize their cursor movement.

The invention can take the form of an entirely hardware embodiment, an entirely software embodiment, or an embodiment containing both hardware and software elements. In a preferred embodiment, the invention is implemented in software, which includes, but is not limited to, firmware, resident software, and microcode.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, or an optical disk. Current examples of optical disks include compact disk-read-only memory (CD-ROM), compact disk-read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times the code must be retrieved from bulk storage during execution.

Input/output or I/O devices (including, but not limited to, keyboards, displays, pointing devices) can be coupled to the system either directly or through intervening I/O controllers.

Network adapters may also be coupled to the system to enable the data processing system to become coupled to other data processing systems, or remote printers, or storage devices through intervening private, or public networks. Modems, cable modems, and Ethernet cards are just a few of the currently available types of network adapters.

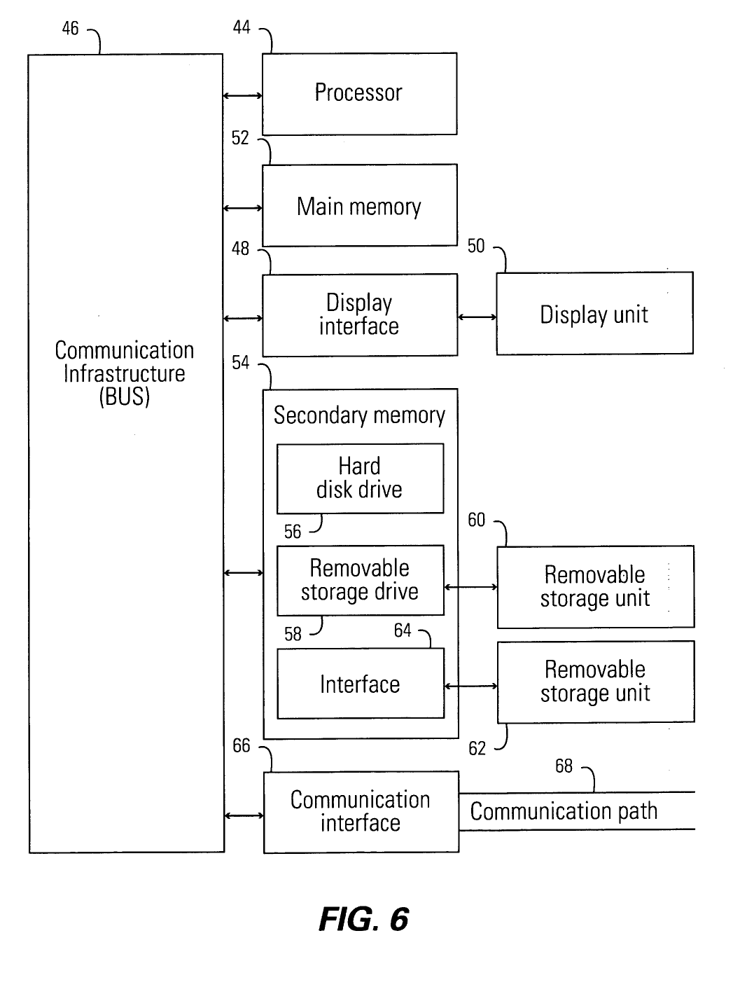

FIG. 6 is a high level block diagram showing an information processing system useful for implementing one embodiment of the present invention. The computer system includes one or more processors, such as processor 44. The processor 44 is connected to a communication infrastructure 46 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 48 that forwards graphics, text, and other data from the communication infrastructure 46 (or from a frame buffer not shown) for display on a display unit 50. The computer system also includes a main memory 52, preferably random access memory (RAM), and may also include a secondary memory 54. The secondary memory 54 may include, for example, a hard disk drive 56 and/or a removable storage drive 58, representing, for example, a floppy disk drive, a magnetic tape drive, or an optical disk drive. The removable storage drive 58 reads from and/or writes to a removable storage unit 60 in a manner well known to those having ordinary skill in the art. Removable storage unit 60 represents, for example, a floppy disk, a compact disc, a magnetic tape, or an optical disk, etc., which is read by and written to by removable storage drive 58. As will be appreciated, the removable storage unit 60 includes a computer readable medium having stored therein computer software and/or data.

In alternative embodiments, the secondary memory 54 may include other similar means for allowing computer programs or other instructions to be loaded into the computer system. Such means may include, for example, a removable storage unit 62 and an interface 64. Examples of such means may include a program cartridge and cartridge interface (such as that found in video game devices), a removable memory chip (such as an EPROM, or PROM) and associated socket, and other removable storage units 62 and interfaces 64 which allow software and data to be transferred from the removable storage unit 62 to the computer system.

The computer system may also include a communications interface 66. Communications interface 66 allows software and data to be transferred between the computer system and external devices. Examples of communications interface 66 may include a modem, a network interface (such as an Ethernet card), a communications port, or a PCMCIA slot and card, etc. Software and data transferred via communications interface 66 are in the form of signals which may be, for example, electronic, electromagnetic, optical, or other signals capable of being received by communications interface 66. These signals are provided to communications interface 66 via a communications path (i.e., channel) 68. This channel 68 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 52 and secondary memory 54, removable storage drive 58, and a hard disk installed in hard disk drive 56.

Computer programs (also called computer control logic) are stored in main memory 52 and/or secondary memory 54. Computer programs may also be received via communications interface 66. Such computer programs, when executed, enable the computer system to perform the features of the present invention as discussed herein. In particular, the computer programs, when executed, enable the processor 44 to perform the features of the computer system. Accordingly, such computer programs represent controllers of the computer system.

From the above description, it can be seen that the present invention provides a system, computer program product, and method for supporting sub-document updates and queries in an inverted index. References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

While the preferred embodiments of the present invention have been described in detail, it will be understood that modifications and adaptations to the embodiments shown may occur to one of ordinary skill in the art without departing from the scope of the present invention as set forth in the following claims. Thus, the scope of this invention is to be construed according to the appended claims and not limited by the specific details disclosed in the exemplary embodiments.

We claim:

1. A method of updating a partitioned index of a dataset comprising:
indexing a document by separating a document into sections, wherein at least one of said sections is contained in at least one partition of said partitioned index; and
updating said partitioned index using an updated version of said document by updating only those sections of said index corresponding to sections of said document that have been updated in said updated version of said document.

2. The method of claim 1 wherein each section is fully contained in only one partition and wherein different ones of said sections are contained in different partitions of said partitioned index.

3. The method of claim 1 wherein said index is an inverted index.

4. The method of claim 1 further comprising generating a posting list comprising, a document identifier, and a section identifier for each occurrence of a term in said dataset.

5. The method of claim 4 wherein said generating further comprises generating a payload storing additional information about each occurrence of said term.

6. The method of claim 4 further comprising indexing said posting lists in a tree representation.

7. The method of claim 6 further comprising accessing one of said posting lists for one of said terms using an index cursor.

8. The method of claim 1, wherein said document includes metadata and content, and wherein said indexing further comprises indexing said metadata in a first section and indexing said content in a second section.

9. A method of searching a dataset having a plurality of documents comprising:
indexing said dataset using a partitioned inverted index, each document having a plurality of document sections, each document section indexed by at most one partition; and
searching said index by searching across said document sections.

10. The method of claim 9, wherein said searching comprises receiving a query and evaluating said query across partitions.

11. The method of claim 10 further comprising minimizing the number of index cursor moves using information regarding said sections and partitions.

12. The method of claim 9 further comprising updating said partitioned inverted index in response to an updated version of said document by updating those sections of said index corresponding to sections of said document that have been updated in said updated version, and not updating those sections that have not been updated in said updated version.

13. A partitioned inverted index comprising:
an ingestion thread receiving a work item and placing it in a queue;
a sort-write thread for dequeuing said work item, sorting said work item to create a new index partition and writing said new index partition to disk;
a merge manager thread for determining when to merge partitions;
a merge thread for merging partitions in response to an instruction from said merge manager; and
a state manager thread for receiving a notification from said sort-write thread of said new index partition and for updating an index state, wherein said sort-write thread, said merge manager thread, said merge thread, and said state manager threads operate in parallel.

14. The partitioned inverted index of claim 13 wherein said work item is an updated document.

15. The partitioned inverted index of claim 13 wherein said work item is an index section, said index section being created by separating a document into indexable sections, such that different ones of said indexable sections are contained in different partitions of said partitioned index.

16. A computer program product comprising a computer usable medium having a computer readable program, wherein said computer readable program when executed on a computer causes said computer to:
index a document by separating a document into sections, wherein at least one of said sections is contained in at least one partition of a partitioned index; and
update said partitioned index using an updated version of said document by updating only those sections of said index corresponding to sections of said document that have been updated in said updated version of said document.

17. The computer program product of claim 16 wherein said computer readable program further causes said computer to minimize the number of index cursor moves.

18. The computer program product of claim 17 wherein said computer readable program further causes said computer to minimize the number of index cursor moves by determining which cursor move is the best next cursor move.

19. The computer program product of claim 18 wherein said computer readable program further causes said computer to minimize the number of index cursor moves by determining how far to move said cursor.

20. The computer program product of claim 16 wherein said computer readable program further causes said computer to search said index by searching across said sections.
